(19) United States
(12) Patent Application Publication
(10) Pub. No.: US 2020/0403247 A1
(43) Pub. Date: Dec. 24, 2020

(54) PROTECTIVE LAYER FOR AN ANODE OF A LEAD ACID BATTERY

(71) Applicant: ROGERS CORPORATION, Chandler, AZ (US)

(72) Inventors: Eran Turi, Richboro, PA (US); Brett Kilhenny, Mystic, CT (US); Wei Wang, Waltham, MA (US)

(21) Appl. No.: 16/903,597

(22) Filed: Jun. 17, 2020

Related U.S. Application Data
(60) Provisional application No. 62/864,787, filed on Jun. 21, 2019.

(51) Int. Cl. H01M 4/66; H01M 4/60; H01M 10/06

(52) U.S. Cl. CPC H01M 4/667; H01M 10/06; H01M 4/604; H01M 4/663

(57) ABSTRACT

In an aspect, a lead acid battery comprises a sealed casing comprising sulfuric acid; an anode and a cathode that are both at least partially immersed in the sulfuric acid; wherein the anode comprises a current collector, an active layer, and a protective layer located in between the current collector and the active layer; wherein the protective layer comprises an electrically conductive carbon, a crosslinked, acid functionalized polymer, and an aliphatic acid or derivative thereof, wherein the aliphatic acid comprises a C₆₋₃₀ aliphatic carboxylic acid.

### CROSS-REFERENCE TO RELATED APPLICATION

This application claims the benefit of U.S. Provisional Patent Application Ser. No. 62/864,787 filed June. 21, 2019. The related application is incorporated herein in its entirety by reference.

### BACKGROUND

Disclosed herein is a protective layer for an anode, which can be used in a battery.

Each electrochemical cell within a battery contains at least one pair of negative and positive electrodes. Each electrode comprises an active material that is coated onto an electronically conductive current collector. As a cell discharges, electrochemical reactions in a negative active material produce electrons that migrate toward the negative current collector, which conducts the electron flow toward the cell negative terminal as electricity. At the same time, electrochemical reactions in a positive active material consume electrons that migrate from the positive current collector, which conducts the electron flow from the positive terminal as electricity. During cell charging, the direction of the electric flow reverses, but the current collectors perform the same function in directing the electron flow.

In conventional lead acid batteries, current collectors are Pb metal or alloys of Pb that commonly include minor amounts of Sb, Ca, and/or Sn. Because the acid electrolyte used in lead acid batteries corrodes metal, the Pb alloys provide a greater degree of corrosion resistance to the acid compared to Pb metal alone, and thereby impart some acid resistance to the current collectors. However, the Pb alloys merely delay corrosion growth and do not prevent it. These alloys simply decrease the kinetics of the corrosion reaction.

Ultimately, corrosion by sulfuric acid electrolyte solution leads to a formation of PbSO₄ on the current collector surface. Unfortunately, PbSO₄ is not electronically conductive and the corrosion results in the formation of an electronic insulating layer at the interface of the current collector and the active material. This insulating layer defeats the function of the current collector by blocking electric flow to the current collector. In addition, PbSO₄ in the acid electrolyte acid is soluble to an insignificant degree, rendering the insulating layer of PbSO₄ robust and difficult to displace. The net result of the corrosion of current collector metal is the defeat of electric flow in a cell, which diminishes or destroys the ability of a battery to store energy.

Improved methods of preventing or reducing the corrosion in lead acid batteries is desired.

### BRIEF SUMMARY

Disclosed herein is an anode for a lead acid battery comprising a protective layer.

In an aspect, a lead acid battery comprises a sealed casing comprising sulfuric acid; an anode and a cathode that are both at least partially immersed in the sulfuric acid; wherein the anode comprises a current collector, an active layer, and a protective layer located in between the current collector and the active layer; wherein the protective layer comprises an electrically conductive carbon, a crosslinked, acid functionalized polymer, and an aliphatic acid or derivative thereof, wherein the aliphatic acid comprises a C₆₋₃₀ aliphatic carboxylic acid.

In another aspect, a method of making an anode of the lead acid battery comprises disposing a curable composition comprising an acid functionalized polymer, the aliphatic acid, a crosslinker, and the electrically conductive carbon onto a current collector; curing the curable composition to form the crosslinked, acid functionalized polymer of the protective layer; and depositing the active layer as a coating or laminate on the protective layer.

The above described and other features are exemplified by the following figures, detailed description, and claims.

### BRIEF DESCRIPTION OF THE DRAWINGS

The figures are exemplary aspects, wherein the like elements are numbered alike. The figures are provided to illustrate the present disclosure and are not intended to limit devices made in accordance with the disclosure to the materials, conditions, or process parameters set forth herein.

FIG. 1 is an illustration of a lead acid battery;

FIG. 2 is an illustration of an anode;

FIG. 3 is a graphical illustration of the discharge capacity with cycling of the battery of the example; and

FIG. 4 is a graphical illustration of the voltage with time for discharge-charge cycle of the battery of the example.

### DETAILED DESCRIPTION

Conventional current collector technology used in lead acid batteries can result in corrosion that leads to the erosion of battery performance with time and ultimately to battery failure. A relatively minor amount of corroded metal formed at the surface of a current collector can effectively block electronic flow to the cell terminals and produce this undesirable outcome. The corrosion mechanism is particularly relevant to PbC battery chemistry, where a carbon negative active material replaces the conventional Pb metal as the negative active material. The inherent porosity of the carbon anode readily permits acid to penetrate through the carbon electrode coating to access the metal current collector surface.

A protective layer was developed that is capable of reducing or preventing corrosion of current collectors in lead acid batteries, with specific benefit when used in lead carbon batteries. The protective layer comprises an electrically conductive carbon and a crosslinked, acid functionalized polymer. The electrically conductive carbon can reduce the electronic resistance of the protective layer and the acid functionality can improve the adhesiveness of the protective layer to the current collector. The protective layer can further comprise an aliphatic acid to incorporate hydrophobicity to the protective layer, enabling it to repel the acid electrolyte and thereby further protect the current collector from chemical degradation by the acid. Thereby, the protective layer can block the sulfuric acid from detrimental contact with the surface of the current collector, while providing adhesion to the current collector and electronic conductivity through its conductive carbon content.

It was further found that a thickness of the protective layer of only 1 to 13 micrometers, or 1 to 10 micrometers can be sufficient to protect the current collector from corroding. This result is surprising as current commercially available acid resistant coatings are generally much thicker, for example, up to hundreds of micrometers thick. The ability to cover the current collector surface and function as a protective layer at a low thickness reduces electronic resistance through the protective layer by reducing the electronic path length.

The protective layer comprises a crosslinked, acid functionalized polymer. The crosslinked, acid functionalized polymer can be derived from a reactive mixture comprising an acid functionalized polymer and a crosslinking agent. The acid functionalized polymer can comprise at least one of a plurality of pendant carboxylic acid groups or a plurality of pendant hydroxyl groups that can crosslink with the crosslinking agent. The acid functionalized polymer can comprise at least one of a poly((meth)acrylic acid), a polysiloxane, a polysilane, or a polyurethane. Each of the foregoing can be a homopolymer or a copolymer. The acid functionalized polymer can comprise a poly((meth)acrylic acid) or a copolymer thereof. For example, the poly((meth)acrylic acid) can comprise at least one of a copolymer of ethylene and (meth)acrylic acid, a copolymer of (meth)acrylic acid and ethyl acrylate, or a copolymer of (meth)acrylic acid and butyl acrylate. The acid functionalized polymer can comprise a poly(ethylene-co-acrylic acid).

The crosslinking agent is multifunctional, in that it comprises 2 or more, or 2 to 10 functional groups. The functional groups of the crosslinking agent can comprise at least one of a hydroxyl group, a carboxylic acid group, an isocyanate group, an aziridinyl group, or an epoxy group. The crosslinking agent can comprise at least one of an aliphatic diol or an aliphatic diacid (for example, a C₂₋₁₂ aliphatic diol or a C₂₋₁₂ dicarboxylic acid), 1-aziridinepropanoic acid, 2-methyl-2-ethyl-2-[[3-(2-methyl-1-aziridinyl)-1-oxopropoxy]methyl]-1,3-propandiyl ester, pentaerythritol-tris-[B-(aziridinyl)propionate], an alkylated melamine (for example, a methylated melamine or a butylated melamine), a methylated melamine-formaldehyde modified styrene allyl alcohol, or a multifunctional isocyanate (for example, toluene diisocyanate). The crosslinked, acid functionalized polymer can comprise a crosslinking moiety derived from at least one of a multifunctional acid, a multifunctional amine, a multifunctional silane, or a multifunctional isocyanate.

The crosslinked, acid functionalized polymer can be derived from a curable composition comprising 50 to 99 wt % of the acid functionalized polymer and 1 to 50 wt % of the crosslinker both based on a total weight of the acid functionalized polymer and the crosslinker.

The protective layer can comprise an aliphatic acid (also referred to herein a long chain aliphatic carboxylic acid), or a derivative thereof. The aliphatic acid can comprise a C₆₋₃₀ aliphatic acid, a C₉₋₃₀ aliphatic acid, or a C₁₁₋₂₀ aliphatic acid having one carboxylic acid group. The aliphatic acid can comprise at least one of lauric acid, myristic acid, oleic acid, stearic acid, or arachidic acid. The aliphatic acid can be grafted onto the crosslinked, acid functionalized polymer by reacting the aliphatic acid with a reactive group (for example, with an acid functionalization) of the crosslinked, acid functionalized polymer before or after forming the protective layer to form a plurality of aliphatic pendant groups on the crosslinked, acid functionalized polymer as derivatives of the aliphatic acid. The aliphatic acid can be reacted with a reactive group of the crosslinked, acid functionalized polymer located on a surface of the protective layer. Covalently bonding the aliphatic acid to the crosslinked, acid functionalized polymer to form a derivative of the aliphatic acid can prevent the aliphatic acid from migrating out of the protective layer.

The amount of the aliphatic acid can be adjusted to achieve sufficient hydrophobicity to repel the acid electrolyte solution, while also achieving a sufficient degree of bonding of the primer coating to the current collector. In general though, the protective layer can comprise 5 to 45 wt % of the aliphatic acid based on the total weight of the protective layer. The grafting efficiency of the aliphatic acid on the crosslinked, acid functionalized polymer, as defined by the weight of the grafted aliphatic acid divided by the total weight of the grafted aliphatic acid and the crosslinked, acid functionalized polymer times 100, can be 0.1 to 50%, or 5 to 45%.

The protective layer can further comprise at least one of a polymer (for example, polyolefin, polyvinylidene fluoride, or polytetrafluoroethylene), a non-conductive filler (for example, silica, alumina, or titanium dioxide), or a metal filler (for example, comprising silver, copper, or nickel). These components can be present in amounts sufficient to adjust a desired property of the protective layer, for example at least one of cost, robustness (e.g., mechanical strength), electrical conductivity, or the like.

The protective layer can comprise 30 to 95 wt % of the combined amount of the crosslinked, acid functionalized polymer and the aliphatic acid or derivative thereof based on the total weight of the protective layer. The protective layer can comprise 30 to 95 wt % of the crosslinked, acid functionalized polymer comprising a plurality of aliphatic pendant groups derived from the aliphatic acid, based on the total weight of the protective layer.

The protective layer comprises an electrically conductive carbon. The electrically conductive carbon can be one that is electrochemically stable in H₂SO₄. The electrically conductive carbon can comprise at least one of carbon black, graphite (for example, graphite particles, graphite fibers, or graphite fibrils), carbon nanotubes, or graphene. The electrically conductive carbon can comprise a carbon isotope and can offer benefits such as improved electrical conductivity or improved acid resistance.

The electrically conductive carbon can be particulate having a D50 particle size by weight of 0.01 to 10 micrometers. The protective layer can comprise 5 to 70 wt% of the electrically conductive carbon based on the total weight of the protective layer.

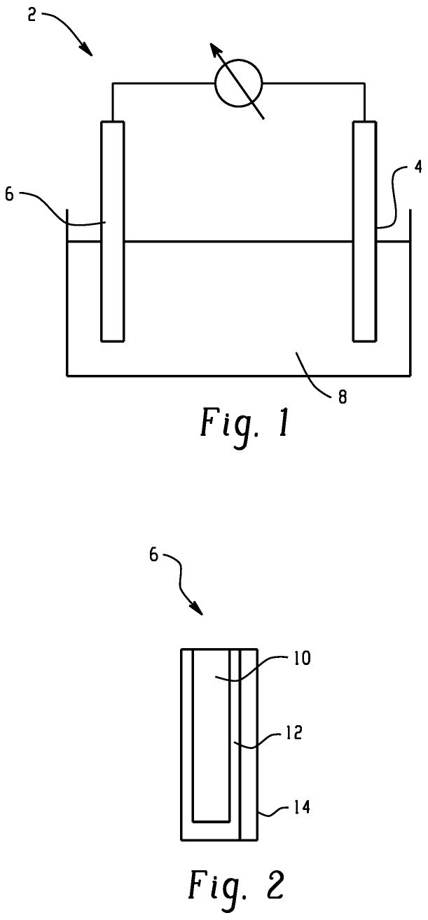

The protective layer can be used as a coating on an anode of a lead acid battery. An example of a lead acid battery is illustrated in FIG. 1. FIG. 1 shows that lead acid battery 2 comprises a cathode 4 and an anode 6. At least a portion of the electrodes is immersed in a medium 8 comprising sulfuric acid.

FIG. 2 is an illustration of a cross-section of the anode 6. FIG. 2 shows that the anode 6 can comprise a current collector 10 having the protective layer 12 located thereon. The protective layer 12 can be in direct physical contact with the current collector 10 with no intervening layers present. The protective layer 12 can cover substantially all of the surface area of the immersed portion of the current collector 10. For example, the protective layer 12 can over 90 to 100% of the surface area of the current collector 10 that is immersed in the medium 8. The protective layer 12 can further coat at least a portion of the surface area of the current collector 10 that is not immersed in the medium 8. The protective layer 12 can be located on both of the broad surfaces of the current collector as well as on the surface of the edges. An active layer 14 can be located on at least one side of the anode 6 such that the protective layer 12 is located in between the current collector 10 and the active layer 14.

The current collector can comprise at least one of copper, nickel, silver, gold, stainless steel, titanium, or aluminum. The current collector can comprise a metalized polymer, for example, at least one of a metalized polyester, a metalized polyimide, a metalized polyolefin, or a metalized vinyl sheet. The current collector can be in the form of a sheet (for example, having a thickness of greater than or equal to 1 millimeter), a foil (for example, having a thickness of less than 1 millimeter, for example, 15 to 25 micrometers), or a mesh (for example, a woven or unwoven metal wire mesh).

The active layer comprises an active material and an optional binder. The active material can comprise at least one of lead (for example, a lead alloy or a lead coated copper) (to form a lead anode for a lead acid battery) or an activated carbon (to form a carbon anode for a lead carbon battery). The active material can comprise lead and carbon (for example, activated carbon). The activated carbon can have a BET surface area of 300 to 3,000 meters squared per gram (m²/ g), or 350 to 1,000 m²/g. The activated carbon can have a D50 particle size of 5 to 20 micrometers, or 7 to 10 micrometers.

The binder can comprise a fluoropolymer. “Fluoropolymer” as used herein include homopolymers and copolymers that comprise repeat units derived from a fluorinated alpha-olefin monomer, i.e., an alpha-olefin monomer that includes at least one fluorine atom substituent, and optionally, a non-fluorinated, ethylenically unsaturated monomer reactive with the fluorinated alpha-olefin monomer. Exemplary fluorinated alpha-olefin monomers include CF₂=CF₂, CH_{F}=CF₂, CH₂=CF₂, CHCl=CHF, CClF=CF₂, CCl₂=CF₂, CClF=CClF, CHF=CCl₂, CH₂=CClF, CCl₂=CClF, CF₃CF=CF₂, CF₃CF=CHF, CF₃CH=CF₂, CF₃CH=CH₂, CHF₂CH=CHF, and CF₃CH=CH₂, and perfluoro(C₂₋₈ alkyl)vinylethers such as perfluoromethyl vinyl ether, perfluoropropyl vinyl ether, and perfluorooctylvinyl ether. The fluorinated alpha-olefin monomer can comprise at least one of tetrafluoroethylene (CF₂=CF₂), chlorotrifluoroethylene (CClF=CF₂), (perfluorobutyl)ethylene, vinylidene fluoride (CH2=CF₂), or hexafluoropropylene (CF₂=CFCF₃). Exemplary non-fluorinated monoethylenically unsaturated monomers include ethylene, propylene, butene, or ethylenically unsaturated aromatic monomers such as styrene or alpha-methyl-styrene. Exemplary fluoropolymers include poly(chlorotrifluoroethylene) (PCTFE), poly(chlorotrifluoroethylene-propylene), poly(ethylene-tetrafluoroethylene) (ETFE), poly(ethylene-chlorotrifluoroethylene) (ECTFE), poly(hexafluoropropylene), poly(tetrafluoroethylene) (PTFE), poly(tetrafluoroethylene-ethylene-propylene), poly(tetrafluoroethylene-hexafluoropropylene) (also known as fluorinated ethylene-propylene copolymer (PEP)), poly(tetrafluoroethylene-propylene) (also known as fluoroelastomer) (FEPM), poly(tetrafluoroethylene-perfluoropropylene vinyl ether), a copolymer having a tetrafluoroethylene backbone with a fully fluorinated alkoxy side chain (also known as a perfluoroalkoxy polymer (PFA)) (for example, poly(tetrafluoroethylene-perfluoroproplyene vinyl ether)), polyvinylfluoride (PVF), polyvinylidene fluoride (PVDF), poly(vinylidene fluoride-chlorotrifluoroethylene), perfluoropolyether, perfluorosulfonic acid, or perfluoropolyoxetane, preferably perfluoroalkoxy alkane polymer, fluorinated ethylene-propylene, or more preferably perfluoroalkoxy alkane polymer. The fluoropolymer can comprise poly(vinylidene fluoride).

The fluoropolymer can be fibrillated. The fibrillation can occur by imposing a shear force onto an active composition comprising the binder and the activated carbon, for example, by mixing an active composition or by jet milling the active composition.

The electrically conductive filler can comprise an electrically conductive carbon, for example, comprising at least one of graphite or carbon black.

The active layer can comprise greater than or equal to 60 wt %, or 85 to 99 wt % of the activated carbon based on the total weight of the active layer. The active layer can comprise 1 to 40 wt %, or 1 to 20 wt % of the binder based on the total weight of the active layer. The active layer can comprise 0 to 40 wt %, or 0 to 30 wt %, or 1 to 10 wt % of an electrically conductive filler. The active layer can have a thickness of 0.5 to 10 millimeters, 1 to 4 millimeters, or 1.5 to 2.5 millimeters.

The medium of the lead acid battery can comprise sulfuric acid, for example, a liquid sulfuric acid. The medium can comprise a gel electrolyte comprising an aqueous sulfuric acid and a thickening agent in an amount sufficient to render the electrolyte a gel. The gel electrolyte can comprise an alkaline earth metal (for example, a silicate, a sulfate, or a phosphate of calcium or strontium.

The lead acid battery can comprise a sealed casing comprising sulfuric acid; and an anode and a cathode that are both at least partially immersed in the sulfuric acid. The anode can comprise a current collector, an active layer, and a protective layer located in between the current collector and the active layer. The protective layer can comprise an electrically conductive carbon, a crosslinked, acid functionalized polymer, and an aliphatic acid or derivative thereof, wherein the aliphatic acid comprises a C6-30 aliphatic carboxylic acid. The polymer can comprise at least one crosslinking moiety derived from at least one of an acid, an amine, a silane, or an isocyanate. The polymer can comprise a poly((meth)acrylic acid) homopolymer or a poly((meth)acrylic acid) copolymer, for example, a poly(ethylene-co-acrylic acid). The polymer can comprise a crosslinking moiety derived from a crosslinking agent comprising two or more functional groups, wherein the functional groups comprise at least one of a hydroxyl group, a carboxylic acid group, an isocyanate group, an azridinyl group, or an epoxy group. The protective layer can comprise 30 to 95 wt % of the polymer based on the total weight of the protective layer. The electrically conductive carbon can comprise at least one of carbon black, graphite, carbon nanotubes, or graphene. At least a portion of the aliphatic acid can be covalently bound to the crosslinked, acid functionalized polymer. The aliphatic acid can comprise a C₉₋₃₀ aliphatic acid having one acid group. The protective layer can comprise 5 to 45 wt% of the C₆₋₃₀ chain aliphatic carboxylic acid based on the total weight of the protective layer. At least a portion of the aliphatic acid can be covalently bound to the crosslinked, acid functionalized polymer and the grafting efficiency of the aliphatic acid, as defined by the weight of the covalently bound aliphatic acid divided by the total weight of the covalently bound aliphatic acid and the crosslinked acid functionalized polymer times 100, can be 0.1 to 50%, or 5 to 45%. The electrically conductive carbon can be in the form of a particulate having a D50 particle size by weight of 0.01 to 10 micrometers. The protective layer can comprise 5 to 70 wt % of the electrically conductive carbon based on the total weight of the protective layer. The long chain aliphatic carboxylic acid can be covalently bound to the polymer. The long chain aliphatic carboxylic acid can comprise a C_{6- 30} aliphatic acid having one acid group. The protective layer can comprise 5 to 45 wt % of the long chain aliphatic carboxylic acid based on the total weight of the protective layer. The current collector can be planar. The protective layer can be located on the two broad parallel surfaces of the current collector as well as on the edges between the two broad surfaces. The protective layer can cover 90 to 100% of the surface area of the current collector, which is coated with electrode material or immersed in the electrolyte medium. The protective layer can have a thickness of 1 to 13 micrometers. The active layer can comprise activated carbon and a fibrillated fluoropolymer. The active layer can comprise greater than or equal to 60 wt %, or 85 to 99 wt % of the activated carbon based on the total weight of the active layer and 1 to 40 wt %, or 1 to 20 wt % of the binder based on the total weight of the active layer. The active layer can have a thickness of 0.5 to 10 millimeters, or 1.5 to 2.5 millimeters. The protective layer can be in direct physical contact with the active layer and the current collector.

The anode can be prepared by coating the protective layer onto the current collector, for example, by at least one of dip coating, flow coating, spray coating, or laminating. For example, a reactive mixture can be disposed on the current collector and crosslinked to form the crosslinked, acid functionalized polymer. Before or after the crosslinking, at least a portion of the acid functionalizations can be reacted with an aliphatic acid. The active layer can then be formed on the protective layer by laminating a preformed active layer onto the protective layer or by depositing an active composition on the protective layer and forming the active layer.

A method of making an anode of the lead acid battery can comprise disposing a curable composition comprising an acid functionalized polymer, the aliphatic acid, a crosslinker, and the electrically conductive carbon onto a current collector; curing the curable composition to form the crosslinked, acid functionalized polymer of the protective layer; and depositing the active layer as a coating or laminate on the protective layer. The method can comprise reacting at least a portion of the aliphatic acid with the acid functionalized polymer.

The present protective layer can improve the performance of lead acid batteries by mitigating acid corrosion of the current collector, which is a prevalent failure mode in conventional lead acid batteries. When used as a protective layer in an anode of a PbC batteries, the protective layer can be even more important in mitigating acid corrosion as the porosity of the active carbon layer increases acid access to current collector surfaces, representing a greater susceptibility to corrosion and its associated battery failure mode.

While this disclosure is directed to providing a protective layer in conventional lead acid batteries, the present protective layer could be used in other battery configurations, including bipolar electrodes.

The following example is provided to illustrate the present disclosure. The example is merely illustrative and are not intended to limit devices made in accordance with the disclosure to the materials, conditions, or process parameters set forth therein.

### EXAMPLE

A coating mixture comprising 64 parts by mass of poly(ethylene-co-acrylic acid) having 20 wt % acrylic acid content, 32 parts by mass carbon black, 1 part by mass stearic acid, and 3 parts by mass of the crosslinker N,N′-dicyclohexylcarbodiimide, all based on a dry basis, was prepared by mixing MICHELMAN MP4384R (a 25 wt % dispersion of the copolymer) and adding the carbon black using isopropanol as a diluent. The stearic acid and 1 part of the crosslinker were mixed separately to form a paste using xylene as a diluent. The paste was added to the slurry in the rotor-stator, followed by the remaining 2 parts of crosslinker, with xylene used as a wash solvent for the addition. An amount of isopropyl alcohol was added to form the coating mixture.

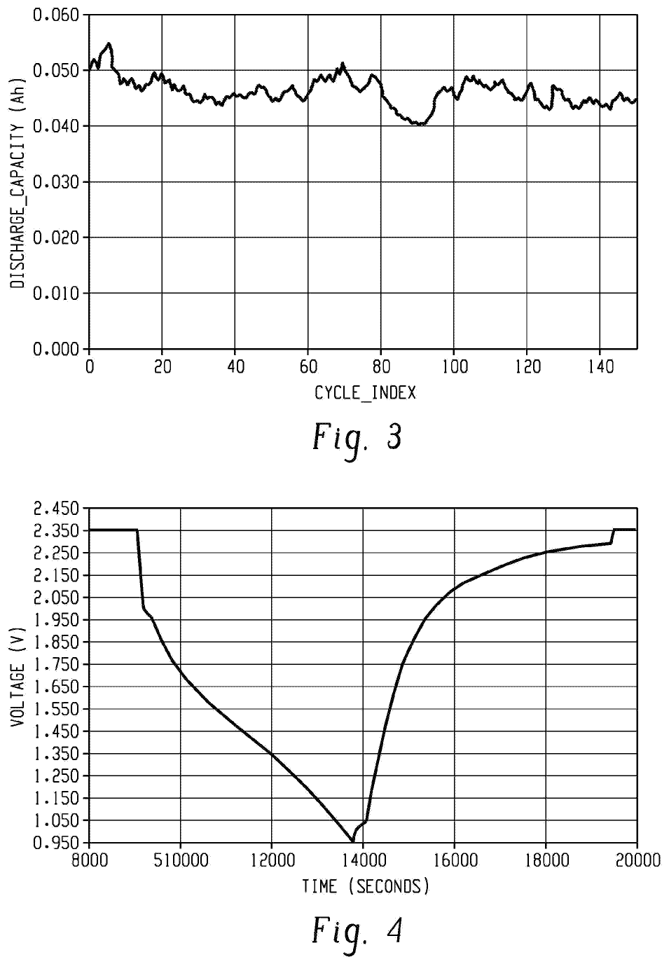

A lead carbon anode was then dip coated and dried using a heat gun to form the protective layer. The drying took less than 30 seconds. The lead carbon anode was then tested in a lead acid battery. The battery cell having a capacity of 39 milliamps per hour was cycled 150 times and the discharge capacity in ampere hour (Ah) was measured and is shown in FIG. 3. FIG. 3 shows that the battery cell can be operated for 150 cycles without a significant change in capacity. The voltage with time for a discharge, rest (with a 32 millivolt Ohmic recovery voltage), and charge cycle was measured with time and is shown in FIG. 4. FIG. 4 shows that there is a typical Ohmic recovery of greater than 100 mV from a 1 C discharge rate.

Set forth below are non-limiting aspects of the present disclosure.

Aspect 1: A lead acid battery comprising: a sealed casing comprising sulfuric acid; an anode and a cathode that are both at least partially immersed in the sulfuric acid; wherein the anode comprises a current collector, an active layer, and a protective layer located in between the current collector and the active layer; wherein the protective layer comprises an electrically conductive carbon, a polymer that is crosslinked and acid functionalized, and a long chain aliphatic carboxylic acid.

Aspect 2: The lead acid battery of Aspect 1, wherein the polymer comprises at least one crosslinking moiety derived from at least one of an acid, an amine, a silane, or an isocyanate.

Aspect 3: The lead acid battery of any one or more of the preceding aspects, wherein the polymer comprises a poly((meth)acrylic acid) homopolymer or a poly((meth)acrylic acid) copolymer, for example, a poly(ethylene)-(acrylic acid) copolymer.

Aspect 4: The lead acid battery of any one or more of the preceding aspects, wherein polymer comprises a crosslinking moiety derived a crosslinking agent comprising two or more functional groups, wherein the functional groups comprise at least one of a hydroxyl group, a carboxylic acid group, an isocyanate group, an azridinyl group, or an epoxy group.

Aspect 5: The lead acid battery of any one or more of the preceding aspects, wherein the protective layer comprises 30 to 95 wt % of the polymer based on the total weight of the protective layer.

Aspect 6: The lead acid battery of any one or more of the preceding aspects, wherein the electrically conductive carbon comprises at least one of carbon black, graphite, carbon nanotubes, or graphene.

Aspect 7: The lead acid battery of any one or more of the preceding aspects, wherein the electrically conductive carbon is particulate having a D50 particle size by weight of 0.01 to 10 micrometers.

Aspect 8: The lead acid battery of any one or more of the preceding aspects, wherein the protective layer comprises 5 to 70 wt % of the electrically conductive carbon based on the total weight of the protective layer.

Aspect 9: The lead acid battery of any one or more of the preceding aspects, wherein the long chain aliphatic carboxylic acid is covalently bound to the polymer.

Aspect 10: The lead acid battery of any one or more of the preceding aspects, wherein at least a portion of the long chain aliphatic carboxylic acid comprises a C6-30 aliphatic acid having one acid group.

Aspect 11: The lead acid battery of any one or more of the preceding aspects, wherein the protective layer comprises 5 to 45 wt % of the long chain aliphatic carboxylic acid based on the total weight of the protective layer.

Aspect 12: The lead acid battery of any one or more of the preceding aspects, wherein the current collector is planar and wherein the protective layer is located on the two broad parallel surfaces of the current collector as well as on the edges between the two broad surfaces.

Aspect 13: The lead acid battery of any one or more of the preceding aspects, wherein the protective layer covers 90 to 100% of the surface area of the current collector, which is coated with electrode material or immersed in the electrolyte medium.

Aspect 14: The lead acid battery of any one or more of the preceding aspects, wherein the protective layer has a thickness of 1 to 13 micrometers.

Aspect 15: The lead acid battery of any one or more of the preceding aspects, wherein the active layer comprises activated carbon and a fibrillated fluoropolymer.

Aspect 16: The lead acid battery of Aspect 15, wherein the active layer comprises greater than or equal to 60 wt %, or 85 to 99 wt % of the activated carbon based on the total weight of the active layer and 1 to 40 wt %, or 1 to 20 wt % of the binder based on the total weight of the active layer.

Aspect 17: The lead acid battery of any one or more of Aspects 15 to 16, wherein the active layer has a thickness of 0.5 to 10 millimeters, or 1.5 to 2.5 millimeters.

Aspect 18: The lead acid battery of any one or more of the preceding aspects, wherein the protective layer is in direct physical contact with the active layer and the current collector.

Aspect 19: A method of making an anode, for example, the anode of the lead acid battery of any one or more of the preceding aspects, comprising: disposing a curable composition comprising a functionalized polymer and a crosslinker onto a current collector; curing the curable composition to form the polymer of the protective layer; and depositing the active layer as a coating or laminate on the protective layer.

Aspect 20: The method of Aspect 19, further comprising reacting at least a portion of the long chain aliphatic carboxylic acid with the polymer.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

The terms “a” and “an” do not denote a limitation of quantity, but rather denote the presence of at least one of the referenced item. The term “or” means “and/or” unless clearly indicated otherwise by context. Reference throughout the specification to “an aspect”, “an embodiment”, “another embodiment”, “some embodiments”, and so forth, means that a particular element (e.g., feature, structure, step, or characteristic) described in connection with the embodiment is included in at least one embodiment described herein, and may or may not be present in other embodiments. In addition, it is to be understood that the described elements may be combined in any suitable manner in the various embodiments.

When an element such as a layer, film, region, or substrate is referred to as being “on” another element, it can be directly on the other element or intervening elements may also be present. In contrast, when an element is referred to as being “directly on” another element, there are no intervening elements present.

The endpoints of all ranges directed to the same component or property are inclusive of the endpoints, are independently combinable, and include all intermediate points and ranges. For example, ranges of “up to 25 wt %, or 5 to 20 wt %” is inclusive of the endpoints and all intermediate values of the ranges of “5 to 25 wt %,” such as 10 to 23 wt %, etc. The term “at least one of” means that the list is inclusive of each element individually, as well as combinations of two or more elements of the list, and combinations of at least one element of the list with like elements not named. Also, the term “combination” is inclusive of blends, mixtures, alloys, reaction products, and the like.

Unless defined otherwise, technical and scientific terms used herein have the same meaning as is commonly understood by one of skill in the art to which this disclosure belongs. The term “(meth)acrylic” is inclusive of both acrylic and methacrylic.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. A lead acid battery comprising:
a sealed casing comprising sulfuric acid;
an anode and a cathode that are both at least partially immersed in the sulfuric acid;
wherein the anode comprises a current collector, an active layer, and a protective layer located in between the current collector and the active layer;
wherein the protective layer comprises
an electrically conductive carbon;
a crosslinked, acid functionalized polymer; and
an aliphatic acid or derivative thereof, wherein the aliphatic acid comprises a C₆₋₃₀ aliphatic carboxylic acid.

2. The lead acid battery of claim 1, wherein the crosslinked, acid functionalized polymer comprises at least one crosslinking moiety derived from at least one of an acid, an amine, a silane, or an isocyanate.

3. The lead acid battery of claim 1, wherein the crosslinked, acid functionalized polymer comprises a poly((meth)acrylic acid) homopolymer or a poly((meth)acrylic acid) copolymer.

4. The lead acid battery of claim 1, wherein crosslinked, acid functionalized polymer comprises a crosslinking moiety derived from a crosslinking agent comprising two or more functional groups, wherein the functional groups comprise at least one of a hydroxyl group, a carboxylic acid group, an isocyanate group, an azridinyl group, or an epoxy group.

5. The lead acid battery of claim 1, wherein the protective layer comprises 30 to 95 wt % of the crosslinked, acid functionalized polymer based on the total weight of the protective layer.

6. The lead acid battery of claim 1, wherein at least a portion of the aliphatic acid is covalently bound to the crosslinked, acid functionalized polymer.

7. The lead acid battery of claim 1, wherein the aliphatic acid comprises a C₉₋₃₀ aliphatic acid having one acid group.

8. The lead acid battery of claim 1, wherein the protective layer comprises 5 to 45 wt % of the C₆₋₃₀ chain aliphatic carboxylic acid based on the total weight of the protective layer; or wherein at least a portion of the aliphatic acid is covalently bound to the crosslinked, acid functionalized polymer and the grafting efficiency of the aliphatic acid, as defined by the weight of the covalently bound aliphatic acid divided by the total weight of the covalently bound aliphatic acid and the crosslinked acid functionalized polymer times 100, is 0.1 to 50%.

9. The lead acid battery of claim 1, wherein the electrically conductive carbon comprises at least one of carbon black, graphite, carbon nanotubes, or graphene.

10. The lead acid battery of claim 1, wherein the protective layer comprises 5 to 70 wt % of the electrically conductive carbon based on the total weight of the protective layer.

11. The lead acid battery of claim 1, wherein the current collector is planar and wherein the protective layer is located on the two broad parallel surfaces of the current collector as well as on the edges between the two broad surfaces.

12. The lead acid battery of claim 1, wherein the protective layer covers 90 to 100% of the surface area of the current collector, which is coated with electrode material or immersed in the electrolyte medium.

13. The lead acid battery of claim 1, wherein the protective layer has a thickness of 1 to 13 micrometers.

14. The lead acid battery of claim 1, wherein the active layer comprises activated carbon and a fibrillated fluoropolymer.

15. The lead acid battery of claim 1, wherein the active layer comprises greater than or equal to 60 wt % of activated carbon based on the total weight of the active layer and 1 to 40 wt % of a binder based on the total weight of the active layer.

16. The lead acid battery of claim 1, wherein the active layer has a thickness of 0.5 to 10 millimeters.

17. The lead acid battery of claim 1, wherein the protective layer is in direct physical contact with the active layer and the current collector.

18. A method of making the anode of the lead acid battery of claim 1, comprising:
disposing a curable composition comprising an acid functionalized polymer, the aliphatic acid, a crosslinker, and the electrically conductive carbon onto a current collector;
curing the curable composition to form the crosslinked, acid functionalized polymer of the protective layer; and
depositing the active layer as a coating or laminate on the protective layer.

19. The method of claim 18, further comprising reacting at least a portion of the aliphatic acid with the acid functionalized polymer.

20. A lead acid battery comprising:
a sealed casing comprising sulfuric acid;
an anode and a cathode that are both at least partially immersed in the sulfuric acid;
wherein the anode comprises a current collector, an active layer, and a protective layer located in between the current collector and the active layer; wherein the protective layer has a thickness of 1 to 13 micrometers;
wherein the protective layer comprises
8 to 70 wt % an electrically conductive carbon based on the total weight of the protective layer, wherein the electrically conductive carbon comprises at least one of carbon black, graphite, carbon nanotubes, or graphene;
30 to 95 wt % of a crosslinked, acid functionalized polymer based on the total weight of the protective layer, wherein the crosslinked, acid functionalized polymer comprises a poly((meth)acrylic acid) homopolymer or a poly((meth)acrylic acid) copolymer; and
an aliphatic acid or derivative thereof, wherein the aliphatic acid comprises a C₆₋₃₀ aliphatic carboxylic acid; and
wherein at least a portion of the aliphatic acid is covalently bound to the crosslinked, acid functionalized polymer and the grafting efficiency of the aliphatic acid, as defined by the weight of the covalently bound aliphatic acid divided by the total weight of the covalently bound aliphatic acid and the crosslinked acid functionalized polymer times 100, is 0.1 to 50%.
